(19) United States
(12) Patent Application Publication
(10) Pub. No.: US 2025/0389904 A1
(43) Pub. Date: Dec. 25, 2025

(54) Non-Physical-Contact Optical Fiber Connector

(71) Applicant: Ayar Labs, Inc., San Jose, CA (US)

(72) Inventors: Jianhua Li, San Jose, CA (US); Chong Zhang, San Jose, CA (US)

(21) Appl. No.: 19/240,778

(22) Filed: Jun. 17, 2025

Related U.S. Application Data
(60) Provisional application No. 63/662,245, filed on Jun. 20, 2024.

(51) Int. Cl. G02B 6/38

(52) U.S. Cl. CPC G02B 6/3885; G02B 6/3881; G02B 6/3883

(57) ABSTRACT

An optical fiber connector assembly includes a base plate, a plurality of optical fibers, a lens array, and a cover plate. A plurality of v-grooves are formed within a top surface of the base plate. The plurality of v-grooves extend from a back side of the base plate to a front side of the base plate. Each of the plurality of v-grooves receives and aligns a corresponding optical fiber. The plurality of optical fibers are respectively disposed within the plurality of v-grooves. The lens array is disposed on the front side of the base plate and includes a plurality of lenses respectively aligned with the plurality of v-grooves, such that optical cores of the plurality of optical fibers are respectively optically coupled with the plurality of lenses. The cover plate is disposed over the plurality of optical fibers within the plurality of v-grooves and is secured to the base plate.

### CROSS-REFERENCE TO RELATED APPLICATIONS

This application claims priority under 35 U.S.C. 119 (e) to U.S. Provisional Patent Application No. 63/662,245, filed on Jun. 20, 2024, the disclosure of which is incorporated herein by reference in its entirety for all purposes.

### BACKGROUND OF THE INVENTION

Optical data communication systems operate by modulating laser light to encode digital data patterns within optical signals. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and other photonic devices, such as photonic integrated circuits within electro-optic and/or photonic integrated chips, among others. Implementation and operation of optical data communication systems is dependent upon having reliable and efficient techniques for connection of optical fibers to each other and/or to other photonic devices. It is within this context that the present invention arises.

### SUMMARY OF THE INVENTION

In an example embodiment, an optical fiber connector assembly is disclosed. The optical fiber connector assembly includes a base plate that has a plurality of v-grooves formed within a top surface of the base plate. The plurality of v-grooves extend from a back side of the base plate to a front side of the base plate. Each of the plurality of v-grooves is configured to receive and align a corresponding optical fiber. The optical fiber connector assembly also includes a plurality of optical fibers respectively disposed within the plurality of v-grooves. The optical fiber connector assembly also includes a lens array disposed on the front side of the base plate. The lens array includes a plurality of lenses respectively aligned with the plurality of v-grooves, such that optical cores of the plurality of optical fibers are respectively optically coupled with the plurality of lenses. The optical fiber connector assembly also includes a cover plate disposed over the plurality of optical fibers within the plurality of v-grooves. The cover plate is secured to the base plate.

In an example embodiment, an optical fiber connector assembly is disclosed. The optical fiber connector assembly includes a base plate that has a plurality of through-holes formed through the base plate. The plurality of through-holes extend from a back side of the base plate to a front side of the base plate. Each of the plurality of through-holes is configured to receive and align a corresponding optical fiber. The optical fiber connector assembly also includes a plurality of optical fibers respectively disposed within the plurality of through-holes. The optical fiber connector assembly also includes a lens array disposed on the front side of the base plate. The lens array includes a plurality of lenses respectively aligned with the plurality of through-holes, such that optical cores of the plurality of optical fibers are respectively optically coupled with the plurality of lenses.

In an example embodiment, a free-space optical coupling assembly is disclosed. The free-space optical coupling assembly includes a first optical fiber connector that has a first lens array that includes a first plurality of lenses respectively optically coupled with a first plurality of optical fibers. The free-space optical coupling assembly also includes a second optical fiber connector that has a second lens array that includes a second plurality of lenses respectively optically coupled with a second plurality of optical fibers. The second optical fiber connector is positioned next to the first optical fiber connector, such that free-space optical coupling is established between the second plurality of lenses and the first plurality of lenses.

### BRIEF DESCRIPTION OF THE DRAWINGS

FIG. 1A shows a top view (transparent view) of an NPC optical fiber connector assembly, in accordance with some embodiments.

FIG. 1B shows a side view (transparent view) of the NPC optical fiber connector assembly, referenced as View A-A in FIG. 1A, in accordance with some embodiments.

FIG. 1C shows a front view (transparent view) of the NPC optical fiber connector assembly, referenced as View B-B in FIG. 1A, in accordance with some embodiments.

FIG. 1D shows a top view (transparent view) of a first NPC optical fiber connector assembly and a second NPC optical fiber connector assembly used to enable free-space optical coupling between a first set of optical fibers within the first NPC optical fiber connector assembly and a second set of optical fibers within the second NPC optical fiber connector assembly, in accordance with some embodiments.

FIG. 2A shows a top view (transparent view) of an NPC optical fiber connector assembly, in accordance with some embodiments.

FIG. 2B shows a side view (transparent view) of the NPC optical fiber connector assembly, referenced as View A-A in FIG. 2A, in accordance with some embodiments.

FIG. 2C shows a front view (transparent view) of the NPC optical fiber connector assembly, referenced as View B-B in FIG. 2A, in accordance with some embodiments.

FIG. 2D shows a top view of a first NPC optical fiber connector assembly and a second NPC optical fiber connector assembly used to enable free-space optical coupling between a first set of optical fibers within the first NPC optical fiber connector assembly and a second set of optical fibers within the second NPC optical fiber connector assembly, in accordance with some embodiments.

FIG. 3A shows the top view (transparent view) of the NPC optical fiber connector assembly of FIG. 2A, with a plug component secured to the base plate, in accordance with some embodiments.

FIG. 3B shows a side view (transparent view) of the NPC optical fiber connector assembly, with the plug component secured to the base plate, referenced as View A-A in FIG. 3A, in accordance with some embodiments.

FIG. 3C shows a front view (transparent view) of the NPC optical fiber connector assembly, with the plug component secured to the base plate, referenced as View B-B in FIG. 3A, in accordance with some embodiments.

FIG. 3D shows a side view (transparent view) of the first NPC optical fiber connector assembly and the second NPC optical fiber connector assembly used to enable free-space optical coupling between the first set of optical fibers within the first NPC optical fiber connector assembly and the second set of optical fibers within the second NPC optical fiber connector assembly, as shown in FIG. 2D, with the first NPC optical fiber connector assembly including a first plug component, and with the second NPC optical fiber connector assembly including a second plug component, in accordance with some embodiments.

FIG. 3E shows the configuration of FIG. 3D in which the first plug component is modified to include an alignment pin stop, and in which the second plug component is modified to include an alignment pin stop, such that a length of the first alignment pin and the second alignment pin controls the distance between the first NPC optical fiber connector assembly and the second NPC optical fiber connector assembly, in accordance with some embodiments.

FIG. 3F shows the configuration of FIG. 3D in which a spreader component is used to control the distance between the first NPC optical fiber connector assembly and the second NPC optical fiber connector assembly, in accordance with some embodiments.

FIG. 3G shows the configuration of FIG. 3D in which a locking device is used to securely hold the first NPC optical fiber connector assembly and the second NPC optical fiber connector assembly together in a fixed spatial relationship with respect to each other, in accordance with some embodiments.

FIG. 3H shows a front view of the NPC optical fiber connector assembly with a receiver region formed in the top surface of the plug component, and with the locking device disposed within the receiver region, in accordance with some embodiments.

FIG. 3I shows the configuration of FIG. 3H in which the base plate and the plug component are formed as respective portions of a same, single component, in accordance with some embodiments.

FIG. 4 shows an NPC optical fiber connector assembly connected with an NPC optical fiber connector assembly, in accordance with some embodiments.

FIG. 5 shows an example optical data communication system implementing the NPC optical fiber connector assemblies disclosed herein, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The ring modulator and associated optical waveguides are fabricated within an electro-optic chip and/or photonic integrated chip (PIC). The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electro-optic and/or PICs. Implementation and operation of optical data communication systems is dependent upon having reliable and efficient techniques for conveyance of optical signals and/or continuous wave laser light between photonic devices, such as between optical fibers, between optical fibers and electro-optic and/or PICs, between optical fibers and interposers, between optical fibers and optically enabled substrates, and between electro-optic and/or PICs, among others. It is within this context that the present invention arises.

Various embodiments are disclosed herein for a non-physical-contact (NPC) optical fiber connector. In some embodiments, any of the various NPCs disclosed herein is implemented as a package optical connector for an optical chiplet. The term optical chiplet as used herein refers to essentially any type of electro-optic chip, PIC, optically enabled semiconductor chip, and/or other type of optical/photonic device to which one or more optical fibers is/are optically connected.

Mechanical transfer (MT) ferrule technology is used in the photonics industry for system-level and/or mid-board optical interfaces. However, the applicability of the extant MT ferrule technology as a package optical connector is limited due to various factors, such as size constraints and susceptibility to damage during high-temperature solder reflow processes, which are common processes in microelectronic packaging. In view of the foregoing, a more robust optical fiber connection approach, as compared with the extant MT ferrule technology, is needed for optical fiber-to-optical chiplet optical connectivity, such as for second level optical interfaces associated with input/output (I/O) optical chiplets. The various NPC optical fiber connector embodiments disclosed herein are particularly useful for optical fiber connection for second level optical interfaces associated with I/O optical chiplets, so as to avoid the limitations of the extant MT ferrule technology. The various NPC optical fiber connector embodiments disclosed herein are also useful and advantageous in many other photonics applications.

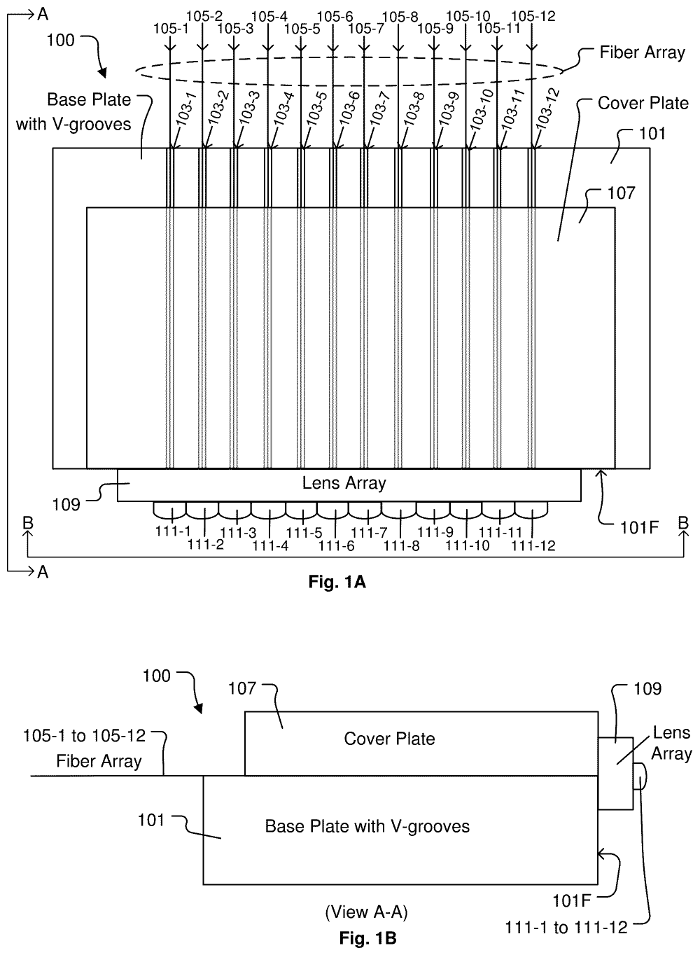

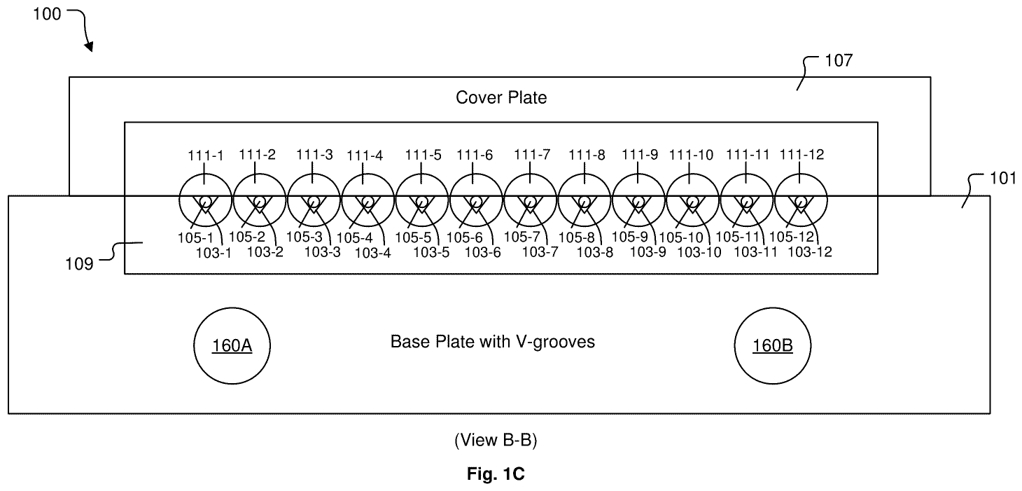

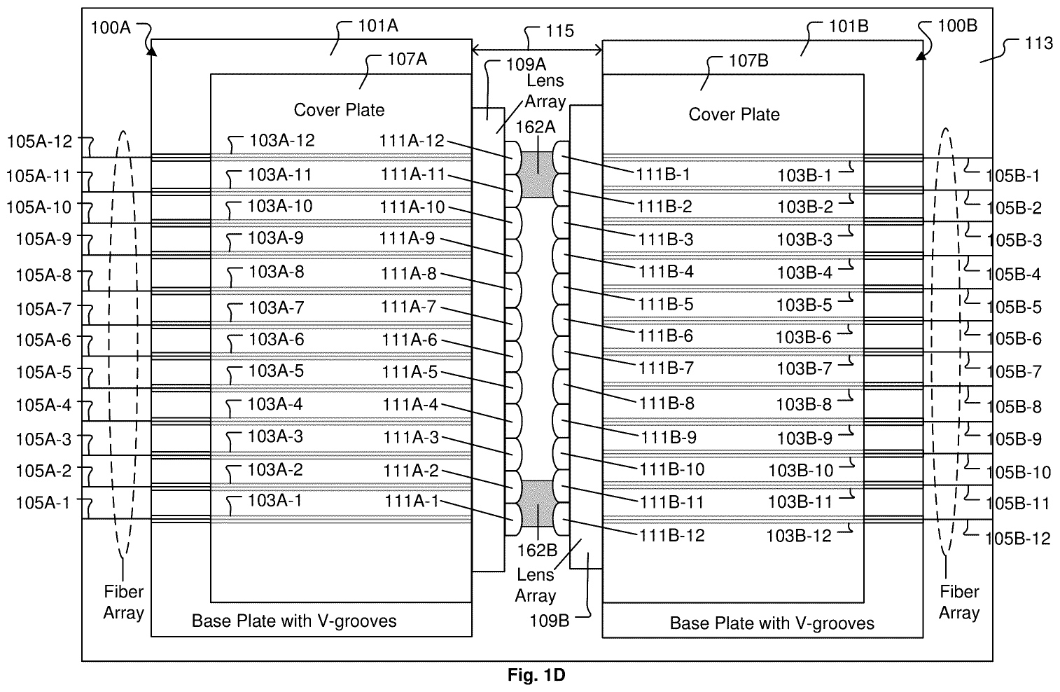

FIG. 1A shows a top view (transparent view) of an NPC optical fiber connector assembly 100, in accordance with some embodiments. FIG. 1B shows a side view (transparent view) of the NPC optical fiber connector assembly 100, referenced as View A-A in FIG. 1A, in accordance with some embodiments. FIG. 1C shows a front view (transparent view) of the NPC optical fiber connector assembly 100, referenced as View B-B in FIG. 1A, in accordance with some embodiments.

The NPC optical fiber connector assembly 100 includes a base plate 101. In some embodiments, the base plate 101 is formed of a material that can withstand the high temperatures associated with solder reflow processes, without undergoing adverse deformation or dimensional variation capable of damaging the optical fibers 105-1 to 105-12 and/or disrupting a proper alignment of the optical fibers 105-1 to 105-12. In various embodiments, the base plate 101 is formed of glass, silicon, or metal. In some embodiments, v-grooves 103-1 to 103-12 are formed within a top surface of the base plate 101. In some embodiments, the v-grooves 103-1 to 103-12 are formed to extend across the top surface of the base plate 101 in a substantially parallel manner with respect to each other. Each of the v-grooves 103-1 to 103-12 is configured to receive and align a corresponding one of optical fibers 105-1 to 105-12. While the example embodiment of FIG. 1A shows twelve v-grooves 103-1 to 103-12 and twelve optical fibers 105-1 to 105-12 respectively corresponding to twelve optical channels, by way of example, it should be understood that other embodiments of the NPC optical fiber connector assembly 100 can include either more than or less than twelve v-grooves 103-1 to 103-12 and either more or less than twelve optical fibers 105-1 to 105-12.

The NPC optical fiber connector assembly 100 also includes a cover plate 107 disposed over the base plate 101 and over the optical fibers 105-1 to 105-12 that are respectively positioned in the v-grooves 103-1 to 103-12. The cover plate 107 is secured to the base plate 101, such as by an adhesive or other securing mechanism. The cover plate 107 is configured to securely hold the optical fibers 105-1 to 105-12 within their respective v-grooves 103-1 to 103-12. In some embodiments, the cover plate 107 is formed of a material that can withstand the high temperatures associated with solder reflow processes, without undergoing adverse deformation or dimensional variation capable of damaging the optical fibers 105-1 to 105-12 and/or disrupting a proper alignment of the optical fibers 105-1 to 105-12. In various embodiments, the cover plate 107 is formed of glass, silicon, or metal. In some embodiments, the cover plate 107 is configured to shield and protect the optical fibers 105-1 to 105-12.

The NPC optical fiber connector assembly 100 also includes a lens array 109 positioned on a front side 101F of the base plate 101. The ends of the optical fibers 105-1 to 105-12 are exposed to the lens array 109 when the optical fibers 105-1 to 105-12 are respectively positioned in the v-grooves 103-1 to 103-12. The lens array 109 includes a separate lens 111-1 to 111-12 for each of the optical fibers 105-1 to 105-12, respectively. Each lens 111-1 to 111-12 is positioned in front of the exposed end of a corresponding one of the optical fibers 105-1 to 105-12. Each of the optical fibers 105-1 to 105-12 is optically coupled with a respective one of the lenses 111-1 to 111-12. In some embodiments, the optical fibers 105-1 to 105-12 are press-fit between the base plate 101 and cover plate 107, such that a friction force between the optical fibers 105-1 to 105-12 and the base plate 101 and/or cover plate 107 is sufficient to mechanically secure the optical fibers 105-1 to 105-12 within the NPC optical fiber connector assembly 100. In these embodiments, an adhesive is not required to mechanically secure the optical fibers 105-1 to 105-12 within the NPC optical fiber connector assembly 100. In some embodiments, the optical fibers 105-1 to 105-12 are bonded with the lens array 109. In some embodiments, an optical index matching adhesive is used to bond the optical fibers 105-1 to 105-12 with the lens array 109, where the optical index matching adhesive is capable of withstanding the high temperatures associated with solder reflow processes, without undergoing adverse deformation or dimensional variation capable of damaging the optical fibers 105-1 to 105-12 and/or disrupting a proper alignment of the optical fibers 105-1 to 105-12. The lens array 109 is configured such that light emitted from each of the optical fibers 105-1 to 105-12 is focused by and emitted through a corresponding one of the lenses 111-1 to 111-12 so as to be output from the NPC optical fiber connector assembly 100. The lens array 109 is also configured such that light that is incident upon each of the lenses 111-1 to 111-12 is focused by and emitted through said lens 111-1 to 111-12 into an optical core of a corresponding one of the optical fibers 105-1 to 105-12 within the NPC optical fiber connector assembly 100.

The NPC optical fiber connector assembly 100 is configured to enable free-space optical coupling between the optical fibers 105-1 to 105-12 and other optical components. FIG. 1D shows a top view (transparent view) of a first NPC optical fiber connector assembly 100A and a second NPC optical fiber connector assembly 100B used to enable free-space optical coupling between a first set of optical fibers 105A-1 to 105A-12 within the first NPC optical fiber connector assembly 100A and a second set of optical fibers 105B-1 to 105B-12 within the second NPC optical fiber connector assembly 100B, in accordance with some embodiments. The first NPC optical fiber connector assembly 100A includes a first base plate 101A and a first cover plate 107A. Similarly, the second NPC optical fiber connector assembly 100B includes a second base plate 101B and a second cover plate 107B. A first set of optical fibers 105A-1 to 105A-12 is disposed with a first set of v-grooves 103A-1 to 103A-12 of the first NPC optical fiber connector assembly 100A. Similarly, a second set of optical fibers 105B-1 to 105B-12 is disposed with a second set of v-grooves 103B-1 to 103B-12 of the second NPC optical fiber connector assembly 100B.

The first NPC optical fiber connector assembly 100A includes a first lens array 109A that includes a first set of lenses 111A-1 to 111A-12. Similarly, the second NPC optical fiber connector assembly 100B includes a second lens array 109B that includes a second set of lenses 111B-1 to 111B-12. The first lens array 109A is optically aligned with the second lens array 109B, such that the first set of lenses 111A-1 to 111A-12 are optically aligned with the second set of lenses 111B-1 to 111B-12, respectively. The first NPC optical fiber connector assembly 100A is spaced apart from the second NPC optical fiber connector assembly 100B by a distance 115, such that light emitted from any lens of the first set of lenses 111A-1 to 111A-12 is optically received by a corresponding lens of the second set of lenses 111B-1 to 111B-12, and such that light emitted from any lens of the second set of lenses 111B-1 to 111B-12 is optically received by a corresponding lens of the first set of lenses 111A-1 to 111A-12. It should be appreciated that the first NPC optical fiber connector assembly 100A and the second NPC optical fiber connector assembly 100B are not required to physically contact each other to enable optically coupling between the first set of optical fibers 105A-1 to 105A-12 and the second set of optical fibers 105B-1 to 105B-12. In some embodiments, the first NPC optical fiber connector assembly 100A and the second NPC optical fiber connector assembly 100B are positioned within a housing 113 to maintain positional accuracy between the first NPC optical fiber connector assembly 100A and the second NPC optical fiber connector assembly 100B. Also, it should be understood that while the example of FIG. 1D shows two of the NPC optical fiber connector assemblies 100A and 100B optically coupled to each other, in various other embodiments, one NPC optical fiber connector assembly 100 can be optically coupled to one or more other photonic devices that are not another instance of the NPC optical fiber connector assembly 100, so long as each of the one or more other photonic devices has an optical capability to optically couple with the lenses 111-1 to 111-12 of the lens assembly 109. In these embodiments, each of the one or more other photonic devices is a conjugate assembly of the NPC optical fiber connector assembly 100.

In some embodiments, the base plate 101 optionally includes alignment pin receptacles 160A and 160B, such as shown in FIG. 1C. In these embodiments, alignment pins 162A and 162B are inserted into the alignment pin receptacles 160A and 160B (one alignment pin 162A, 162B per one alignment pin receptacle 160A, 160B, such as shown in FIG. 1D. The alignment pin receptacles 160A, 160B and the alignment pins 162A, 162B are collectively configured to provide for spatial alignment of the first NPC optical fiber connector assembly 100A with the second NPC optical fiber connector assembly 100B, such that optical coupling between the lens array 109A and the lens array 109B is achieved and maintained. In various embodiments, the alignment pins are formed of metal, rigid plastic, ceramic, or other material that has sufficient rigidity and mechanical strength to maintain spatial alignment of the first NPC optical fiber connector assembly 100A with the second NPC optical fiber connector assembly 100B.

As discussed with regard to FIGS. 1A through 1D, in an example embodiment, the optical fiber connector assembly 100 is disclosed to include the base plate 101, the plurality of optical fibers 105-1 to 105-12, the lens array 109, and the cover plate 107. The base plate 101 has the plurality of v-grooves 103-1 to 103-12 formed within the top surface of the base plate 101. The plurality of v-grooves 103-1 to 103-12 extend from a back side of the base plate 101 to a front side of the base plate 101. The plurality of v-grooves 103-1 to 103-12 are oriented parallel with each other. In some embodiments, adjacent ones of the plurality of v-grooves 103-1 to 103-12 are separated by a substantially equal spacing. Each of the plurality of v-grooves 103-1 to 103-12 is configured to receive and align a corresponding optical fiber 105-1 to 105-12. The plurality of optical fibers 105-1 to 105-12 are respectively disposed within the plurality of v-grooves 103-1 to 103-12. In some embodiments, the plurality of optical fibers 105-1 to 105-12 are press-fit between the base plate 101 and the cover plate 107. The lens array 109 is disposed on the front side of the base plate 101. The lens array 109 includes a plurality of lenses 111-1 to 111-12 respectively aligned with the plurality of v-grooves 103-1 to 103-12, such that optical cores of the plurality of optical fibers 105-1 to 105-12 are respectively optically coupled with the plurality of lenses 111-1 to 111-12. In some embodiments, an optical index matching adhesive is disposed to bond the plurality of optical fibers 105-1 to 105-1 with the lens array 109. The lens array 109 is configured to provide for free-space optical coupling between the plurality of optical fibers 105-1 to 105-12 and a separate optical component. The cover plate 107 is disposed over the plurality of optical fibers 105-1 to 105-12 within the plurality of v-grooves 103-1 to 103-12, with the cover plate 107 being secured to the base plate 101. In some embodiments, the base plate 101 and the cover plate 107 are formed of a material that withstands a solder reflow process temperature without undergoing deformation or dimensional variation. In some embodiments, the base plate 101 and the cover plate 107 are formed of one or more of glass, silicon, and metal.

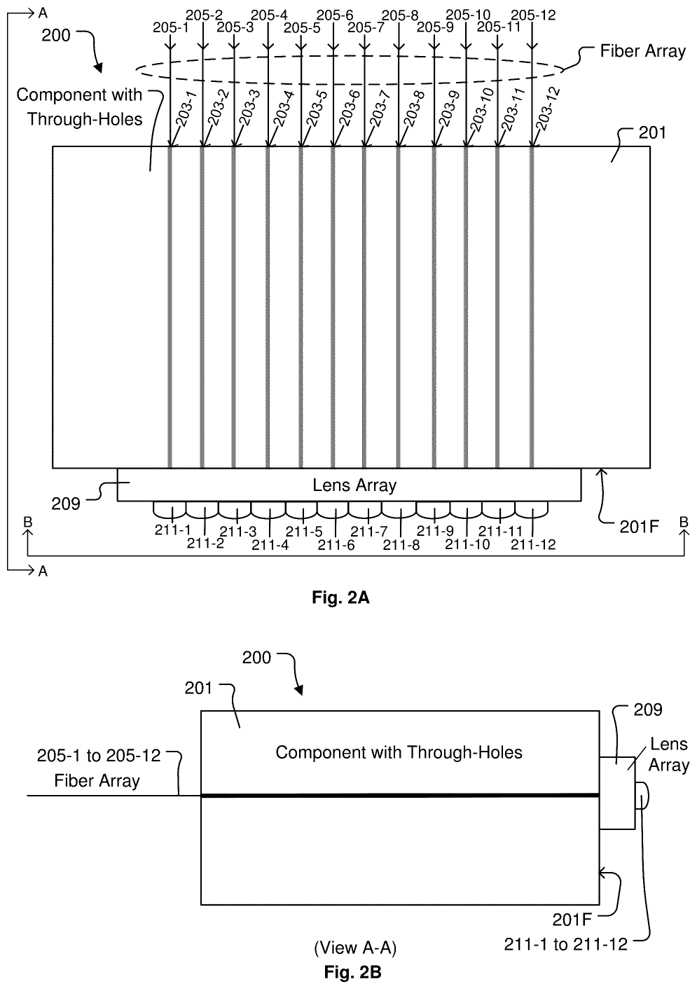

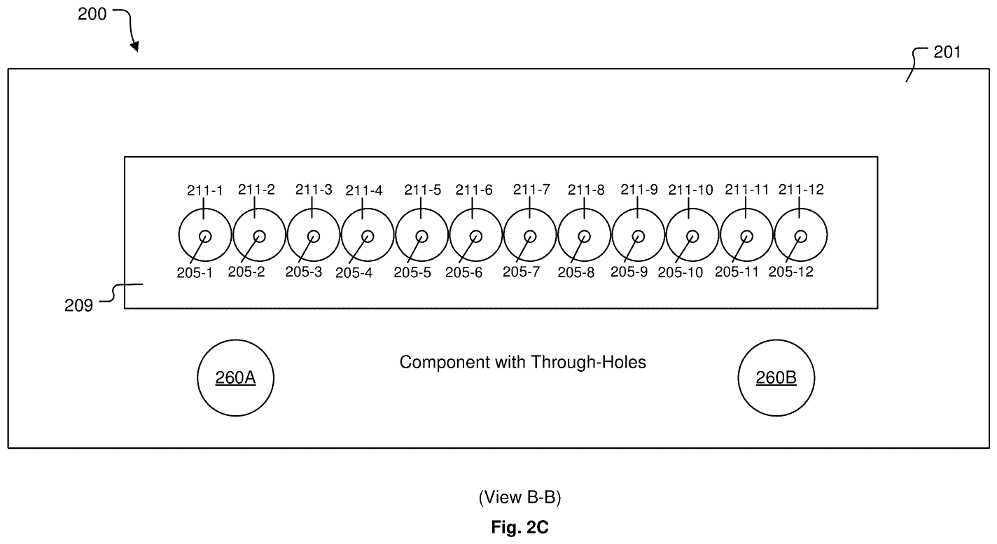

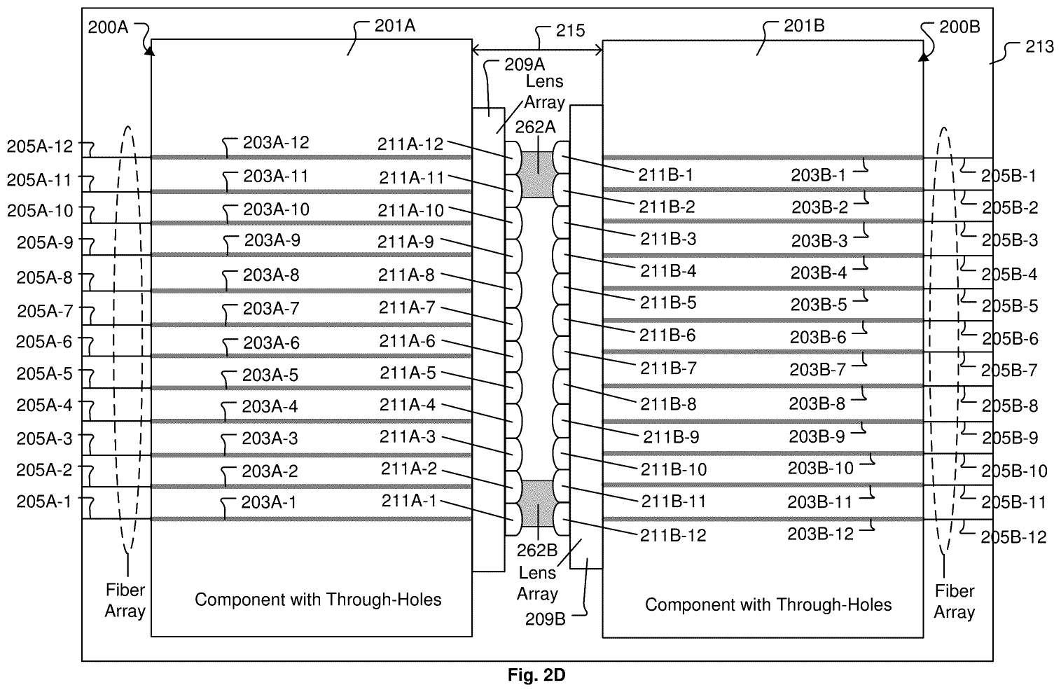

FIG. 2A shows a top view (transparent view) of an NPC optical fiber connector assembly 200, in accordance with some embodiments. FIG. 2B shows a side view (transparent view) of the NPC optical fiber connector assembly 200, referenced as View A-A in FIG. 2A, in accordance with some embodiments. FIG. 2C shows a front view (transparent view) of the NPC optical fiber connector assembly 200, referenced as View B-B in FIG. 2A, in accordance with some embodiments.

The NPC optical fiber connector assembly 200 includes a base plate 201. In some embodiments, the base plate 201 is formed of a material that can withstand the high temperatures associated with solder reflow processes, without undergoing adverse deformation or dimensional variation capable of damaging the optical fibers 205-1 to 205-12 and/or disrupting a proper alignment of the optical fibers 205-1 to 205-12. In various embodiments, the base plate 201 is formed of glass, silicon, or metal. In some embodiments, through-holes 203-1 to 203-12 are formed through the base plate 201. Each of the through-holes 203-1 to 203-12 is configured to accommodate insertion of a corresponding one of the optical fibers 205-1 to 205-12 through said through-hole 203-1 to 203-12. In some embodiments, the through-holes 203-1 to 203-12 are formed to extend through the base plate 201 in a substantially parallel manner with respect to each other. Each of the through-holes 203-1 to 203-12 is configured to receive and align a corresponding one of optical fibers 205-1 to 205-12. While the example embodiment of FIG. 2A shows twelve through-holes 203-1 to 203-12 and twelve optical fibers 205-1 to 205-12 respectively corresponding to twelve optical channels, by way of example, it should be understood that other embodiments of the NPC optical fiber connector assembly 200 can include either more than or less than twelve through-holes 203-1 to 203-12 and either more or less than twelve optical fibers 205-1 to 205-12.

The NPC optical fiber connector assembly 200 also includes a lens array 209 positioned on a front side 201F of the base plate 201. The ends of the optical fibers 205-1 to 205-12 are exposed to the lens array 209 when the optical fibers 205-1 to 205-12 are respectively positioned in the through-holes 203-1 to 203-12. The lens array 209 includes a lens 211-1 to 211-12 for each of the optical fibers 205-1 to 205-12, respectively. Each lens 211-1 to 211-12 is positioned in front of the exposed end of a corresponding one of the optical fibers 205-1 to 205-12. Each of the optical fibers 205-1 to 205-12 is optically coupled with a respective one of the lenses 211-1 to 211-12. In some embodiments, the optical fibers 205-1 to 205-12 are bonded to the base plate 201 to mechanically secure the optical fibers 205-1 to 205-12 within the NPC optical fiber connector assembly 200. In some embodiments a structural adhesive is used to bond the optical fibers 205-1 to 205-12 to the base plate 201, where the structural adhesive is capable of withstanding the high temperatures associated with solder reflow processes, without undergoing adverse deformation or dimensional variation capable of damaging the optical fibers 205-1 to 205-12 and/or disrupting a proper alignment of the optical fibers 205-1 to 205-12. In some embodiments, the optical fibers 205-1 to 205-12 are bonded with the lens array 209. In some embodiments, an optical index matching adhesive is used to bond the optical fibers 205-1 to 205-12 with the lens array 209, where the optical index matching adhesive is capable of withstanding the high temperatures associated with solder reflow processes, without undergoing adverse deformation or dimensional variation capable of damaging the optical fibers 205-1 to 205-12 and/or disrupting a proper alignment of the optical fibers 205-1 to 205-12. The lens array 209 is configured such that light emitted from each of the optical fibers 205-1 to 205-12 is focused by and emitted through a corresponding one of the lenses 211-1 to 211-12 so as to be output from the NPC optical fiber connector assembly 200. The lens array 209 is also configured such that light that is incident upon each of the lenses 211-1 to 211-12 is focused by and emitted through said lens 211-1 to 211-12 into an optical core of a corresponding one of the optical fibers 205-1 to 205-12 within the NPC optical fiber connector assembly 200.

The NPC optical fiber connector assembly 200 is configured to enable free-space optical coupling between the optical fibers 205-1 to 205-12 and other optical components. FIG. 2D shows a top view of a first NPC optical fiber connector assembly 200A and a second NPC optical fiber connector assembly 200B used to enable free-space optical coupling between a first set of optical fibers 205A-1 to 205A-12 within the first NPC optical fiber connector assembly 200A and a second set of optical fibers 205B-1 to 205B-12 within the second NPC optical fiber connector assembly 200B, in accordance with some embodiments. The first NPC optical fiber connector assembly 200A includes a first base plate 201A and a first cover plate 207A. Similarly, the second NPC optical fiber connector assembly 200B includes a second base plate 201B and a second cover plate 207B. A first set of optical fibers 205A-1 to 205A-12 is disposed with a first set of through-holes 203A-1 to 203A-12 of the first NPC optical fiber connector assembly 200A. Similarly, a second set of optical fibers 205B-1 to 205B-12 is disposed with a second set of through-holes 203B-1 to 203B-12 of the second NPC optical fiber connector assembly 200B.

The first NPC optical fiber connector assembly 200A includes a first lens array 209A that includes a first set of lenses 211A-1 to 211A-12. Similarly, the second NPC optical fiber connector assembly 200B includes a second lens array 209B that includes a second set of lenses 211B-1 to 211B-12. The first lens array 209A is optically aligned with the second lens array 209B, such that the first set of lenses 211A-1 to 211A-12 are optically aligned with the second set of lenses 211B-1 to 211B-12, respectively. The first NPC optical fiber connector assembly 200A is spaced apart from the second NPC optical fiber connector assembly 200B by a distance 215, such that light emitted from any lens of the first set of lenses 211A-1 to 211A-12 is optically received by a corresponding lens of the second set of lenses 211B-1 to 211B-12, and such that light emitted from any lens of the second set of lenses 211B-1 to 211B-12 is optically received by a corresponding lens of the first set of lenses 211A-1 to 211A-12. It should be appreciated that the first NPC optical fiber connector assembly 200A and the second NPC optical fiber connector assembly 200B are not required to physically contact each other to enable optical coupling between the first set of optical fibers 205A-1 to 205A-12 and the second set of optical fibers 205B-1 to 205B-12. In some embodiments, the first NPC optical fiber connector assembly 200A and the second NPC optical fiber connector assembly 200B are positioned within a housing 213 to maintain positional accuracy between the first NPC optical fiber connector assembly 200A and the second NPC optical fiber connector assembly 200B. Also, it should be understood that while the example of FIG. 2D shows two of the NPC optical fiber connector assemblies 200A and 200B optically coupled to each other, in various other embodiments, one NPC optical fiber connector assembly 200 can be optically coupled to one or more other photonic devices that are not another instance of the NPC optical fiber connector assembly 200, so long as each of the one or more other photonic devices has an optical capability to optically couple with the lenses 211-1 to 211-12 of the lens assembly 209. In these embodiments, each of the one or more other photonic devices is a conjugate assembly of the NPC optical fiber connector assembly 200.

In some embodiments, the base plate 201 optionally includes alignment pin receptacles 260A and 260B, such as shown in FIG. 2C. In these embodiments, alignment pins 262A and 262B are inserted into the alignment pin receptacles 260A and 260B (one alignment pin 262A, 262B per one alignment pin receptacle 260A, 260B, such as shown in FIG. 2D. The alignment pin receptacles 260A, 260B and the alignment pins 262A, 262B are collectively configured to provide for spatial alignment of the first NPC optical fiber connector assembly 200A with the second NPC optical fiber connector assembly 200B, such that optical coupling between the lens array 209A and the lens array 209B is achieved and maintained. In various embodiments, the alignment pins are formed of metal, rigid plastic, ceramic, or other material that has sufficient rigidity and mechanical strength to maintain spatial alignment of the first NPC optical fiber connector assembly 200A with the second NPC optical fiber connector assembly 200B.

As discussed with regard to FIGS. 2A through 2D, in an example embodiment, the optical fiber connector assembly 200 is disclosed to include the base plate 201, the plurality of optical fibers 205-1 to 205-12, and the lens array 209. The base plate 201 has the plurality of through-holes 203-1 to 203-12 formed through the base plate 201. The plurality of through-holes 203-1 to 203-12 extend from a back side of the base plate 201 to a front side of the base plate 201. Each of the plurality of through-holes 203-1 to 203-12 is configured to receive and align a corresponding optical fiber 205-1 to 205-12. The plurality of through-holes 203-1 to 203-12 are oriented parallel with each other. In some embodiments, adjacent ones of the plurality of through-holes 203-1 to 203-12 are separated by a substantially equal spacing. The plurality of optical fibers 205-1 to 205-12 are respectively disposed within the plurality of through-holes 203-1 to 203-12. In some embodiments, the plurality of optical fibers 205-1 to 205-12 are bonded to the base plate 201. The lens array 209 is disposed on the front side of the base plate 201. The lens array 209 includes a plurality of lenses 211-1 to 211-12 respectively aligned with the plurality of through-holes 203-1 to 203-12, such that optical cores of the plurality of optical fibers 205-1 to 205-12 are respectively optically coupled with the plurality of lenses 211-1 to 211-12. In some embodiments, an optical index matching adhesive disposed to bond the plurality of optical fibers 205-1 to 205-12 with the lens array 209. The lens array 209 is configured to provide for free-space optical coupling between the plurality of optical fibers 205-1 to 205-12 and a separate optical component. In some embodiments, the base plate 201 is formed of a material that withstands a solder reflow process temperature without undergoing deformation or dimensional variation. In some embodiments, the base plate 201 is formed of one or more of glass, silicon, and metal.

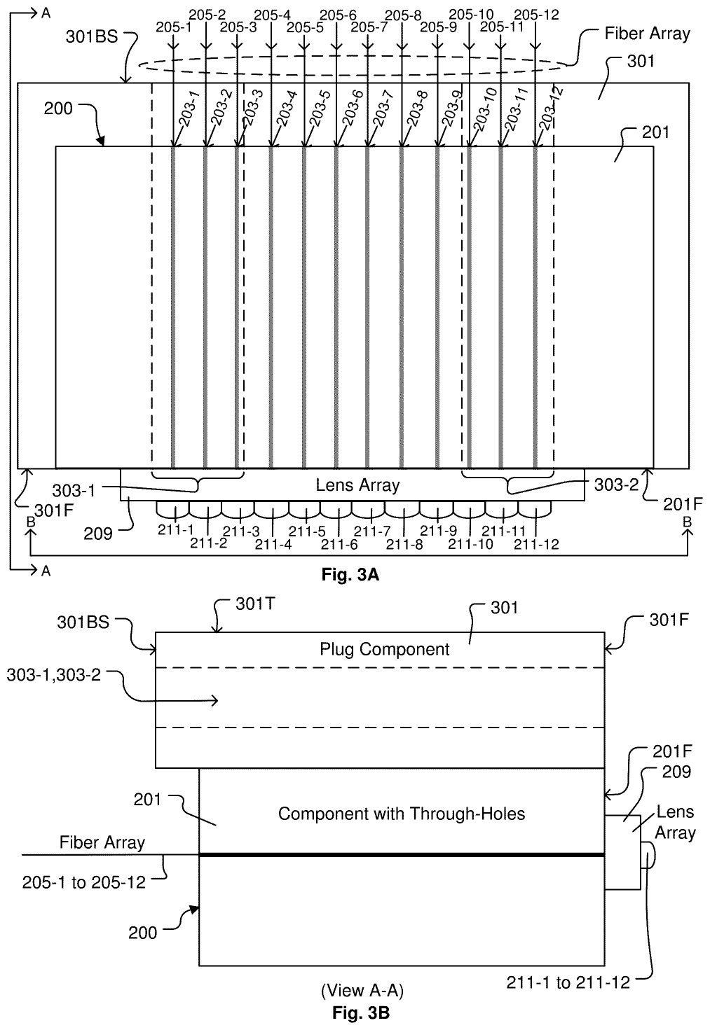

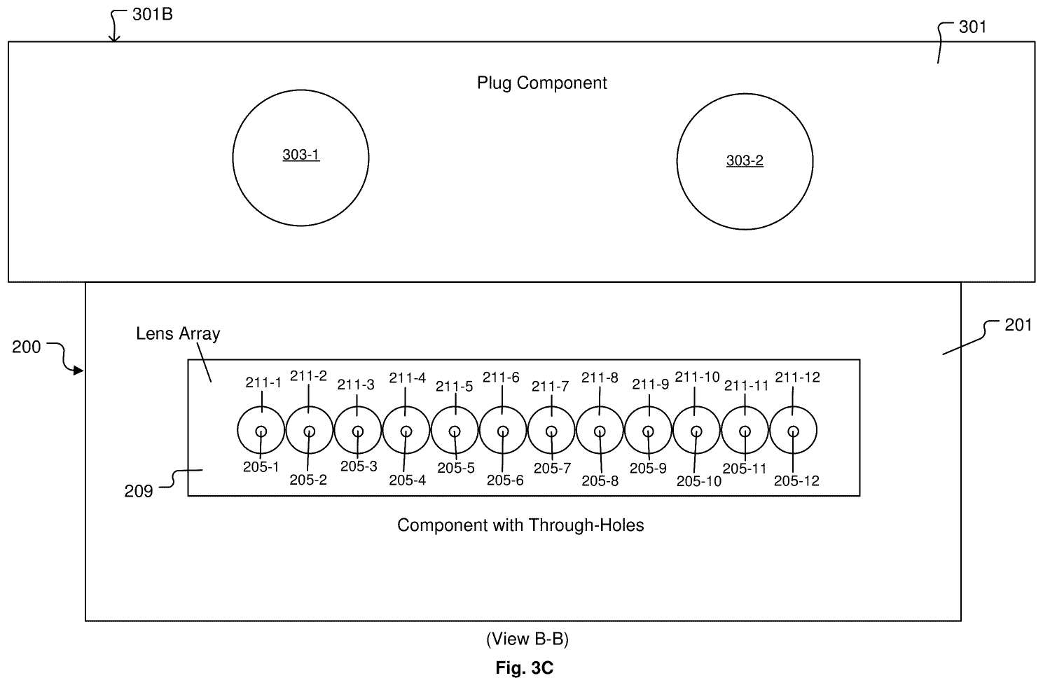

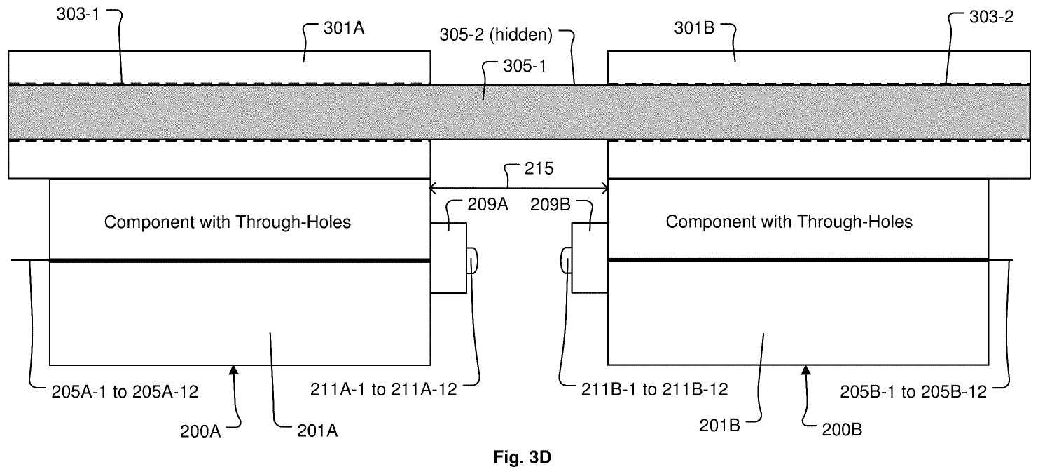

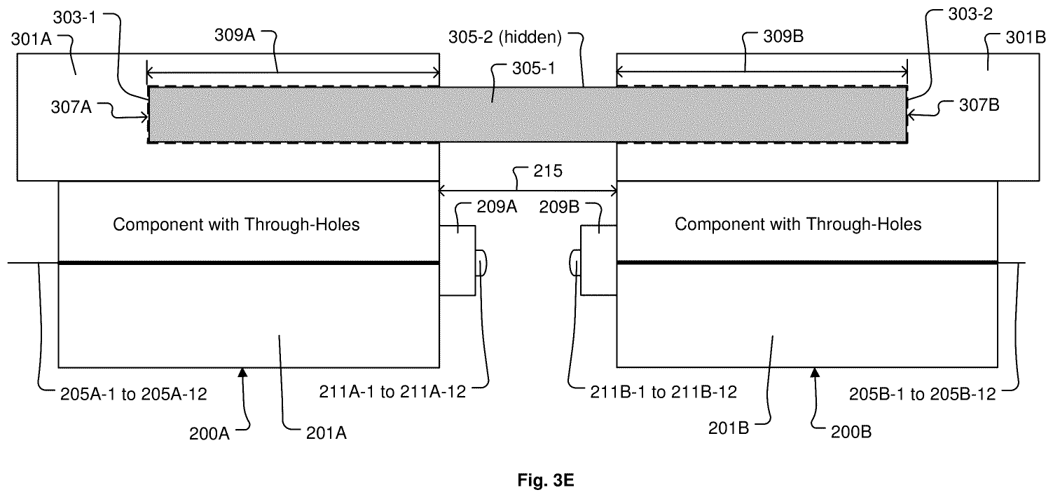

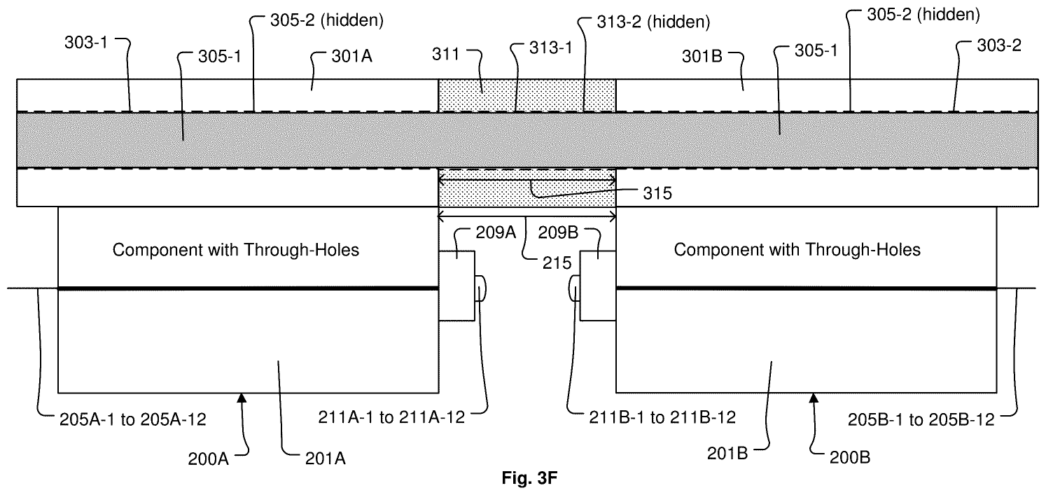

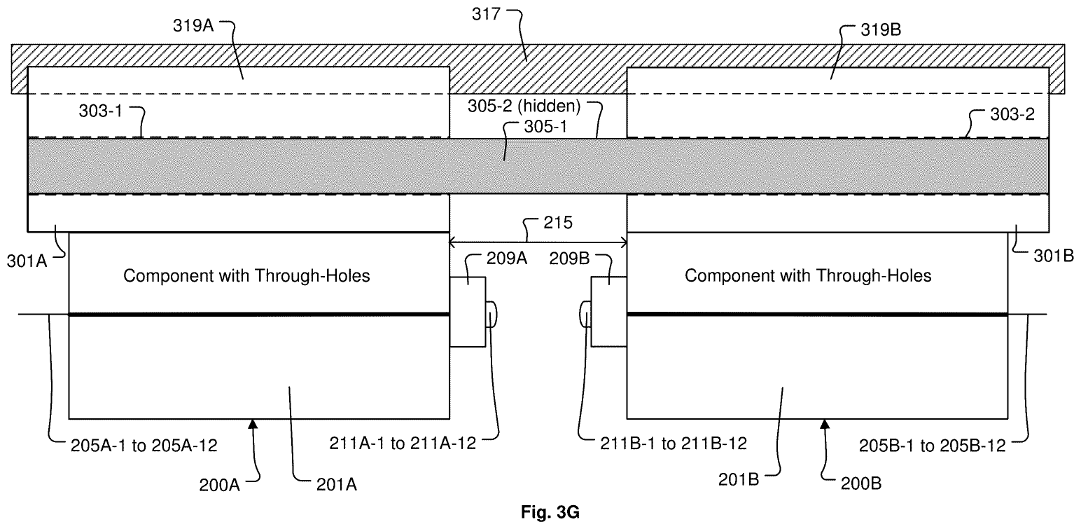

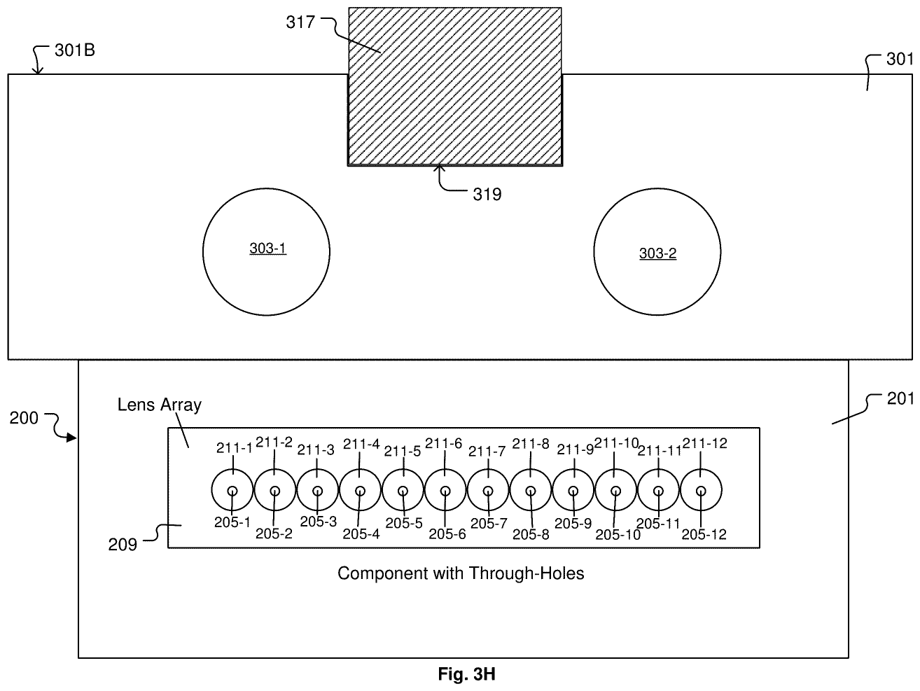

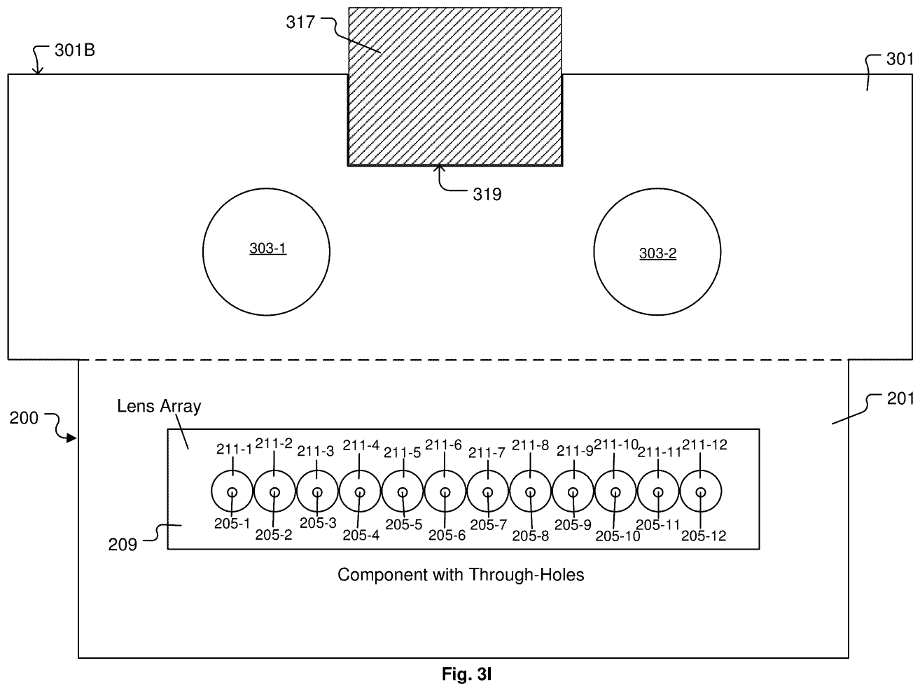

FIG. 3A shows the top view (transparent view) of the NPC optical fiber connector assembly 200 of FIG. 2A, with a plug component 301 secured to the base plate 201, in accordance with some embodiments. FIG. 3B shows a side view (transparent view) of the NPC optical fiber connector assembly 200, with the plug component 301 secured to the base plate 201, referenced as View A-A in FIG. 3A, in accordance with some embodiments. FIG. 3C shows a front view (transparent view) of the NPC optical fiber connector assembly 200, with the plug component 301 secured to the base plate 201, referenced as View B-B in FIG. 3A, in accordance with some embodiments.

In some embodiments, the plug component 301 includes a first receiver slot 303-1 and a second receiver slot 303-2. In some embodiments, each of the first receiver slot 303-1 and the second receiver slot 303-2 is configured as a hole extending through the plug component in an orientation substantially perpendicular to a front side 301F of the plug component 301, and substantially parallel to a top surface 301T of the plug component 301. In some embodiments, a vertical cross-section of each of the first receiver slot 303-1 and the second receiver slot 303-2 has a substantially circular shape. However, it should be understood that in various embodiments, the vertical cross-section of each of the first receiver slot 303-1 and the second receiver slot 303-2 can have essentially any shape. Also, in some embodiments, each of the first receiver slot 303-1 and the second receiver slot 303-2 extends from the front side 301F of the plug component 301 to a back side 301BS of the plug component 301. However, in other embodiments, the first receiver slot 303-1 and/or the second receiver slot 303-2 extends from the front side 301F of the plug component 301 to a stopping point at an intermediate position between the front side 301F of the plug component 301 and the back side 301BS of the plug component 301.

In some embodiments, the plug component 301 is formed of a material that can withstand the high temperatures associated with solder reflow processes, without undergoing adverse deformation or dimensional variation capable of damaging the optical fibers 205-1 to 205-12 and/or disrupting a proper alignment of the optical fibers 205-1 to 205-12. In various embodiments, the plug component 301 is formed of glass, silicon, or metal. In some embodiments, the plug component 301 is secured to the base plate 201 with a structural adhesive, where the structural adhesive is capable of withstanding the high temperatures associated with solder reflow processes, without undergoing adverse deformation or dimensional variation capable of damaging the optical fibers 205-1 to 205-12 and/or disrupting a proper alignment of the optical fibers 205-1 to 205-12. Also, the example embodiment of FIGS. 3A, 3B, and 3C shows the plug component 301 and the base plate 201 as two separate components that are secured together, it should be understood that in other embodiments the plug component 301 is integrally formed as part of the base plate 201, such that the plug component 301 and the base plate 201 are respective portions of a same, single component.

FIG. 3D shows a side view (transparent view) of the first NPC optical fiber connector assembly 200A and the second NPC optical fiber connector assembly 200B used to enable free-space optical coupling between the first set of optical fibers 205A-1 to 205A-12 within the first NPC optical fiber connector assembly 200A and the second set of optical fibers 205B-1 to 205B-12 within the second NPC optical fiber connector assembly 200B, as shown in FIG. 2D, with the first NPC optical fiber connector assembly 200A including a first plug component 301A, and with the second NPC optical fiber connector assembly 200B including a second plug component 301B, in accordance with some embodiments. Each of the first plug component 301A and the second plug component 301B corresponds to the plug component 301 described with regard to FIGS. 3A, 3B, and 3C. The first receiver slot 303-1 of the first plug component 301A is substantially aligned with the second receiver slot 303-2 of the second plug component 301B. Similarly, the second receiver slot 303-2 of the first plug component 301A is substantially aligned with the first receiver slot 303-1 of the second plug component 301B. A first alignment pin 305-1 is inserted into both the first receiver slot 303-1 of the first plug component 301A and the second receiver slot 303-2 of the second plug component 301B. Similarly, as second alignment pin 305-2 (hidden behind the first alignment pin 305-1 in FIG. 3D) is inserted into both the second receiver slot 303-2 of the first plug component 301A and the first receiver slot 303-1 of the second plug component 301B. The first alignment pin 305-1 and the second alignment pin 305-2 are substantially straight, so as to optically align the first set of lenses 211A-1 to 211A-12 of the first lens array 209A of the first NPC optical fiber connector assembly 200A with the second set of lenses 211B-1 to 211B-12 of the second lens array 209B of the second NPC optical fiber connector assembly 200B. In some embodiments, a vertical cross-sectional shape of each of the first alignment pin 305-1 and the second alignment pin 305-2 substantially matches a vertical cross-sectional shape of each of the first receiver slots 303-1 of the first and second plug components 301A, 301B, and of each of the second receiver slots 303-2 of the first and second plug components 301A, 301B.

In some embodiments, the first alignment pin 305-1 and the second alignment pin 305-2 are permanently secured to either the first plug component 301A of the first NPC optical fiber connector assembly 200A or the second plug component 301B of the second NPC optical fiber connector assembly 200B, so as to make a male version of the NPC optical fiber connector assembly 200. In some embodiments, the first alignment pin 305-1 and the second alignment pin 305-2 are integrally formed as extensions of either the first plug component 301A of the first NPC optical fiber connector assembly 200A or the second plug component 301B of the second NPC optical fiber connector assembly 200B, so as to make a male version of the NPC optical fiber connector assembly 200. In these embodiments, the version of the NPC optical fiber connector assembly 200 having the open first receiver slot 303-1 and the open second receiver slot 303-2 is the female version of the NPC optical fiber connector assembly 200. In these embodiments, joining of the male version of the NPC optical fiber connector assembly 200 with the female version of the NPC optical fiber connector assembly 200 by way of insertion of the first and second alignment pins 305-1, 305-2 into the first and second receiver slots 303-1, 303-2 provides for accurate passive optical alignment of the first set of lenses 211A-1 to 211A-12 of the first lens array 209A of the first NPC optical fiber connector assembly 200A with the second set of lenses 211B-1 to 211B-12 of the second lens array 209B of the second NPC optical fiber connector assembly 200B.

FIG. 3E shows the configuration of FIG. 3D in which the first plug component 301A is modified to include an alignment pin stop 307A, and in which the second plug component 301B is modified to include an alignment pin stop 307B, such that a length of the first alignment pin 305-1 and the second alignment pin 305-2 controls the distance 215 between the first NPC optical fiber connector assembly 200A and the second NPC optical fiber connector assembly 200B, in accordance with some embodiments. The alignment pin stop 307A is located a controlled depth 309A within the first plug component 301A. Similarly, the alignment pin stop 307B is located a controlled depth 309B within the second plug component 301B. The combination of the controlled depth 309A, the controlled depth 309B, and the length of the first alignment pin 305-1 and the second alignment pin 305-2 collectively control the distance 215 between the first NPC optical fiber connector assembly 200A and the second NPC optical fiber connector assembly 200B. In some embodiments, the controlled depth 309A, 309B of the alignment pin stops 307A, 307B of each instance of the NPC optical fiber connector assembly 200 is the same, such that the length of the first alignment pin 305-1 and the second alignment pin 305-2 is used to control the distance 215 between the first NPC optical fiber connector assembly 200A and the second NPC optical fiber connector assembly 200B.

FIG. 3F shows the configuration of FIG. 3D in which a spreader component 311 is used to control the distance 215 between the first NPC optical fiber connector assembly 200A and the second NPC optical fiber connector assembly 200B, in accordance with some embodiments. The spreader component 311 is disposed between and in contact with the first NPC optical fiber connector assembly 200A and the second NPC optical fiber connector assembly 200B, such that a length 315 of the spreader component 311 (as measured perpendicularly between the first plug component 301A and the second plug component 301B) controls the distance 215 between the first NPC optical fiber connector assembly 200A and the second NPC optical fiber connector assembly 200B. The spreader component 311 includes a first through-hole 313-1 through which the first alignment pin 305-1 passes, and a second through-hole 313-2 through which the second alignment pin 305-2 passes. In some embodiments, the each of the first through-hole 313-1 and the second through-hole 313-2 of the spreader component 311 has a vertical cross-sectional shape that substantially matches the vertical cross-sectional shape of the first and second alignment pins 305-1, 305-2.

FIG. 3G shows the configuration of FIG. 3D in which a locking device 317 is used to securely hold the first NPC optical fiber connector assembly 200A and the second NPC optical fiber connector assembly 200B together in a fixed spatial relationship with respect to each other, in accordance with some embodiments. The first plug component 301A includes a receiver region 319A for receiving the locking device 317. Similarly, the second plug component 301B includes a receiver region 319B for receiving the locking device 317. In some embodiments, the receiver region 319A and the receiver region 319B are formed as slots within the top surface of the first plug component 301A and the second plug component 301B, respectively. FIG. 3H shows a front view of the NPC optical fiber connector assembly 200 with a receiver region 319 formed in the top surface 301B of the plug component 301, and with the locking device 317 disposed within the receiver region 319, in accordance with some embodiments. FIG. 3I shows the configuration of FIG. 3H in which the base plate 201 and the plug component 301 are formed as respective portions of a same, single component, in accordance with some embodiments.

As described with regard to FIGS. 3A through 3H, in some embodiments, the plug component 301 is secured to a top surface of the base plate 201. The plug component 301 includes a first receiver slot 303-1 configured to receive a first alignment pin 305-1. The plug component 301 includes a second receiver slot 303-2 configured to receive a second alignment pin 305-2. The first receiver slot 303-1 and the second receiver slot 303-2 are configured to provide for alignment of the lens array 209 with the separate optical component when the first alignment pin 305-1 is inserted into the first receiver slot 303-1 and the second alignment pin 305-2 is inserted into the second receiver slot 303-2. As described with regard to FIG. 3E, in some embodiments, the first receiver slot 303-1 is formed to have the controlled depth 309A within the plug component 301A. Also, the second receiver slot 303-2 is formed to have the controlled depth 309A within the plug component 301. The controlled depth 309A provides for control of the spacing 215 between the optical fiber connector 301A and the separate optical component. Also, as described with regard to FIG. 3I, in some embodiments, the base plate 209 itself includes the plug component 301 that has the first receiver slot 303-1 configured to receive the first alignment pin 305-1 and the second receiver slot 303-2 configured to receive the second alignment pin 305-2. The first receiver slot 303-1 and the second receiver slot 303-2 are configured to provide for alignment of the lens array 209 with the separate optical component when the first alignment pin 305-1 is inserted into the first receiver slot 303-1 and the second alignment pin 305-2 is inserted into the second receiver slot 303-2.

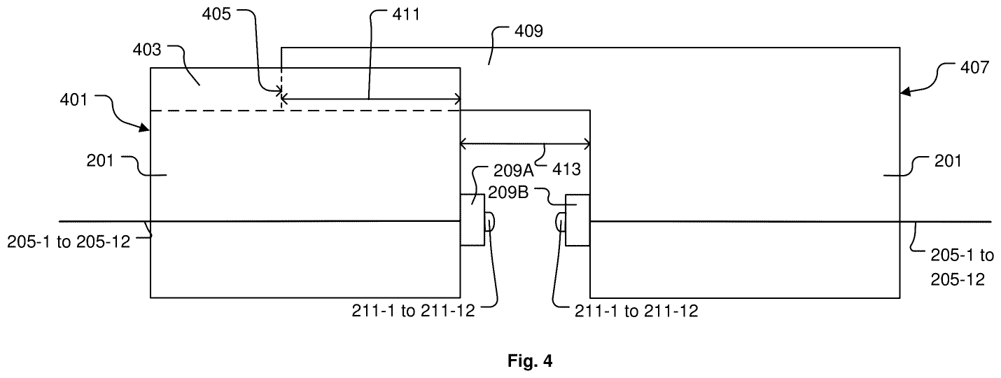

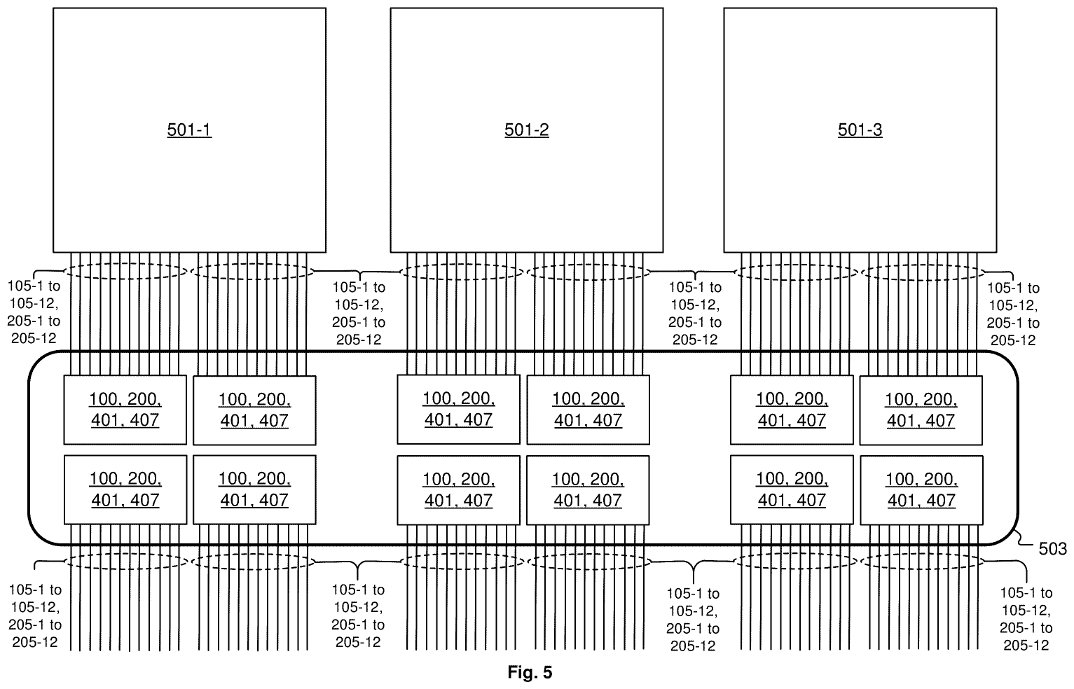

FIG. 4 shows an NPC optical fiber connector assembly 401 connected with an NPC optical fiber connector assembly 407, in accordance with some embodiments. The NPC optical fiber connector assembly 401 is configured in substantially the same manner as the NPC optical fiber connector assembly 200 of FIGS. 2A, 2B, and 2C, with the addition of an attachment channel 403 formed in the top of the base plate 201. Also, the NPC optical fiber connector assembly 407 is configured in substantially the same manner as the NPC optical fiber connector assembly 200 of FIGS. 2A, 2B, and 2C, with the addition of an attachment engagement member 409 formed in the top of the base plate 201. The attachment engagement member 409 is configured to fit into the attachment channel 403, so as to securely join the NPC optical fiber connector assembly 407 to the NPC optical fiber connector assembly 401, with the lens array 209 of the NPC optical fiber connector assembly 407 optically aligned with the lens array 209 of the NPC optical fiber connector assembly 401. In some embodiments, the attachment channel 403 includes a hard stop 405 to control a distance 411 over which the attachment engagement member 409 is inserted into the attachment channel 403, which in turn controls a separation distance 413 between the NPC optical fiber connector assembly 401 and the NPC optical fiber connector assembly 407.

FIG. 5 shows an example optical data communication system implementing the NPC optical fiber connector assemblies 100, 200, 401, and/or 407 disclosed herein, in accordance with some embodiments. Each of multiple optical chiplets 501-1, 501-2, and 501-3 are optically connected to one or more NPC optical fiber connector assemblies 100, 200, 401, and/or 407 by the optical fibers 105-1 to 105-12 or 205-1 to 205-12, as the case may be. Each of these one or more NPC optical fiber connector assemblies 100, 200, 401, and/or 407 is optically connected to another NPC optical fiber connector assembly 100, 200, 401, and/or 407. These other NPC optical fiber connector assemblies 100, 200, 401, and/or 407 also have optical fibers 105-1 to 105-12 or 205-1 to 205-12, as the case may be, which are optically routed and connected to other photonic devices with the optical data communication system. The NPC optical fiber connector assemblies 100, 200, 401, and/or 407 in a given connected pair of the NPC optical fiber connector assemblies 100, 200, 401, and/or 407 are held in a fixed spatial relationship with respect to each other. In some embodiments, a mating force is used to hold a pair of optically connected NPC optical fiber connector assemblies 100, 200, 401, and/or 407 in the fixed spatial relationship with respect to each other. In some embodiments, this mating force is achieved using a spring-loaded clamping mechanism. It should be understood, however, that use of the mating force in these embodiments does not require the two optically connected NPC optical fiber connector assemblies 100, 200, 401, and/or 407 to physically contact each other.

In some embodiments, the optical fibers 105-1 to 105-12 or 205-1 to 205-12 are permanently bonded to the optical chiplets 501-1, 501-2, 501-3. In some embodiments, the optical fibers 105-1 to 105-12 or 205-1 to 205-12 are detachable from the optical chiplets 501-1, 501-2, 501-3, where optical coupling between the optical fibers 105-1 to 105-12 or 205-1 to 205-12 and the optical chiplets 501-1, 501-2, 501-3 implemented using optical grating coupling techniques, optical edge coupling techniques, and/or v-groove-assisted optical coupling techniques, among essentially any other known optical coupling technique.

It should be understood that while the example of FIG. 5 shows three optical chiplets 501-1, 501-2, and 501-3, other embodiments can have any non-zero number of optical chiplets. Also, while the example of FIG. 5 shows twelve optical fibers 105-1 to 105-12 or 205-1 to 205-12, as the case may be, for each of the NPC optical fiber connector assemblies 100, 200, 401, and/or 407, other embodiments can have any non-zero number of optical fibers per NPC optical fiber connector assembly 100, 200, 401, and/or 407.

In some embodiments, a housing structure 503 is implemented to protect the NPC optical fiber connector assemblies 100, 200, 401, and/or 407 from ambient particles and other external hazards. In various embodiments, any given connected pair of NPC optical fiber connector assemblies 100, 200, 401, and/or 407 can have its own housing structure 503. Also, in various embodiments, such as shown in FIG. 5, two or more connected pairs of NPC optical fiber connector assemblies 100, 200, 401, and/or 407 can share a housing structure 503. In various embodiments, the housing structure 503 is formed of metal, plastic, rubber, or combination thereof, or of another suitable material. In some embodiments, the housing structure 503 is secured in a fixed manner on an optical module package, such as on a lid structure or substrate. In some embodiments, the housing structure 503 is a stand-alone structure. In some embodiments, the housing structure 503 is secured in a fixed manner to a printed circuit board (PCB) on which an associated optical module package is disposed.

In some embodiments, such as shown in FIGS. 1D, 2D, 3D through 3I, 4 and 5, a free-space optical coupling assembly is disclosed as including a first optical fiber connector 100A, 200A, 401 and a second optical fiber connector 100B, 200B, 407. The first optical fiber connector 100A, 200A, 401 has a first lens array 109A, 209A that includes the first plurality of lenses 111A-1 to 111A-12, 211A-1 to 211A-12 respectively optically coupled with a first plurality of optical fibers 105A-1 to 105A-12, 205A-1 to 205A-12. The second optical fiber connector 100B, 200B, 407 has a second lens array 109B, 209B that includes the second plurality of lenses 111B-1 to 111B-12, 211B-1 to 211B-12 respectively optically coupled with a second plurality of optical fibers 105B-1 to 105B-12, 205B-1 to 205B-12. The second optical fiber connector 100B, 200B, 407 is positioned next to the first optical fiber connector 100A, 200A, 401, such that free-space optical coupling is established between the second plurality of lenses 111B-1 to 111B-12, 211B-1 to 211B-12 and the first plurality of lenses 111A-1 to 111A-12, 211A-1 to 211A-12. In some embodiments, the first optical fiber connector 100A, 200A, 401 and the second optical fiber connector 100B, 200B, 407 are disposed within the housing 113, 213, where the housing 113, 213 is configured to maintain positional accuracy between the first optical fiber connector 100A, 200A, 401 and the second optical fiber connector 100B, 200B, 407. It should be understood that the each of the various optical fiber connectors 100, 200, 100A, 200A, 401, 407 disclosed herein are usable to optically connect any type of a first photonic device with any type of a second photonic device, wherein the first and second photonic devices include one or more of a semiconductor chip, a semiconductor chiplet, an interposer, a substrates, a waveguide, an optical receiver, an optical transmitter, an optical transceiver, an optical fanout chip, and/or any other type of photonic device to which optical fibers are optically connected, such as in optical data communication systems or any other type of system that relies upon conveyance of optical signals.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An optical fiber connector assembly, comprising:
a base plate having a plurality of v-grooves formed within a top surface of the base plate, the plurality of v-grooves extending from a back side of the base plate to a front side of the base plate, each of the plurality of v-grooves configured to receive and align a corresponding optical fiber;
a plurality of optical fibers respectively disposed within the plurality of v-grooves;
a lens array disposed on the front side of the base plate, the lens array including a plurality of lenses respectively aligned with the plurality of v-grooves such that optical cores of the plurality of optical fibers are respectively optically coupled with the plurality of lenses; and
a cover plate disposed over the plurality of optical fibers within the plurality of v-grooves, wherein the cover plate is secured to the base plate.

2. The optical fiber connector assembly as recited in claim 1, wherein the plurality of v-grooves are oriented parallel with each other.

3. The optical fiber connector assembly as recited in claim 2, wherein adjacent ones of the plurality of v-grooves are separated by a substantially equal spacing.

4. The optical fiber connector assembly as recited in claim 1, wherein the plurality of optical fibers are press-fit between the base plate and the cover plate.

5. The optical fiber connector assembly as recited in claim 1, wherein the base plate and the cover plate are formed of a material that withstands a solder reflow process temperature without undergoing deformation or dimensional variation.

6. The optical fiber connector assembly as recited in claim 5, wherein the base plate and the cover plate are formed of one or more of glass, silicon, and metal.

7. The optical fiber connector assembly as recited in claim 1, further comprising:
an optical index matching adhesive disposed to bond the plurality of optical fibers with the lens array.

8. The optical fiber connector assembly as recited in claim 1, wherein the lens array is configured to provide for free-space optical coupling between the plurality of optical fibers and a separate optical component.

9. An optical fiber connector assembly, comprising:
a base plate having a plurality of through-holes formed through the base plate, the plurality of through-holes extending from a back side of the base plate to a front side of the base plate, each of the plurality of through-holes configured to receive and align a corresponding optical fiber;
a plurality of optical fibers respectively disposed within the plurality of through-holes; and
a lens array disposed on the front side of the base plate, the lens array including a plurality of lenses respectively aligned with the plurality of through-holes such that optical cores of the plurality of optical fibers are respectively optically coupled with the plurality of lenses.

10. The optical fiber connector assembly as recited in claim 9, wherein the plurality of through-holes are oriented parallel with each other.

11. The optical fiber connector assembly as recited in claim 10, wherein adjacent ones of the plurality of through-holes are separated by a substantially equal spacing.

12. The optical fiber connector assembly as recited in claim 9, wherein the plurality of optical fibers are bonded to the base plate.

13. The optical fiber connector assembly as recited in claim 9, wherein the base plate is formed of a material that withstands a solder reflow process temperature without undergoing deformation or dimensional variation.

14. The optical fiber connector assembly as recited in claim 13, wherein the base plate is formed of one or more of glass, silicon, and metal.

15. The optical fiber connector assembly as recited in claim 9, further comprising:
an optical index matching adhesive disposed to bond the plurality of optical fibers with the lens array.

16. The optical fiber connector assembly as recited in claim 9, wherein the lens array is configured to provide for free-space optical coupling between the plurality of optical fibers and a separate optical component.

17. The optical fiber connector assembly as recited in claim 16, further comprising:
a plug component secured to a top surface of the base plate, the plug component including a first receiver slot configured to receive a first alignment pin, the plug component including a second receiver slot configured to receive a second alignment pin, wherein the first receiver slot and the second receiver slot are configured to provide for alignment of the lens array with the separate optical component when the first alignment pin is inserted into the first receiver slot and the second alignment pin is inserted into the second receiver slot.

18. The optical fiber connector assembly as recited in claim 17, wherein the first receiver slot is formed to have a first controlled depth within the plug component, wherein the second receiver slot is formed to have a second controlled depth within the plug component, wherein the first controlled depth and the second controlled depth provide for control of a spacing between the optical fiber connector and the separate optical component.

19. The optical fiber connector assembly as recited in claim 16, wherein the base plate includes a plug component having a first receiver slot configured to receive a first alignment pin, the plug component having a second receiver slot configured to receive a second alignment pin, wherein the first receiver slot and the second receiver slot are configured to provide for alignment of the lens array with the separate optical component when the first alignment pin is inserted into the first receiver slot and the second alignment pin is inserted into the second receiver slot.

20. The optical fiber connector assembly as recited in claim 19, wherein the first receiver slot is formed to have a first controlled depth within the plug component, wherein the second receiver slot is formed to have a second controlled depth within the plug component, wherein the first controlled depth and the second controlled depth provide for control of a spacing between the optical fiber connector and the separate optical component.

21. A free-space optical coupling assembly, comprising:
a first optical fiber connector having a first lens array including a first plurality of lenses respectively optically coupled with a first plurality of optical fibers; and
a second optical fiber connector having a second lens array including a second plurality of lenses respectively optically coupled with a second plurality of optical fibers, wherein the second optical fiber connector is positioned next to the first optical fiber connector such that free-space optical coupling is established between the second plurality of lenses and the first plurality of lenses.

22. The free-space optical coupling assembly as recited in claim 21, further comprising:
a housing, the first optical fiber connector and the second optical fiber connector disposed within the housing, the housing configured to maintain positional accuracy between the first optical fiber connector and the second optical fiber connector.

23. The free-space optical coupling assembly as recited in claim 21, wherein the first optical fiber connector includes a first base plate and a first cover plate, the first base plate having a first plurality of v-grooves formed within a top surface of the first base plate, the first plurality of v-grooves extending from a back side of the first base plate to a front side of the first base plate, each of the first plurality of v-grooves configured to receive and align a corresponding one of the first plurality of optical fibers, the first lens array disposed on the front side of the first base plate, wherein the first plurality of lenses are respectively aligned with the first plurality of v-grooves such that optical cores of the first plurality of optical fibers are respectively optically coupled with the first plurality of lenses, the first cover plate disposed over the first plurality of optical fibers within the first plurality of v-grooves, wherein the first cover plate is secured to the first base plate, and
wherein the second optical fiber connector includes a second base plate and a second cover plate, the second base plate having a second plurality of v-grooves formed within a top surface of the second base plate, the second plurality of v-grooves extending from a back side of the second base plate to a front side of the second base plate, each of the second plurality of v-grooves configured to receive and align a corresponding one of the second plurality of optical fibers, the second lens array disposed on the front side of the second base plate, wherein the second plurality of lenses are respectively aligned with the second plurality of v-grooves such that optical cores of the second plurality of optical fibers are respectively optically coupled with the second plurality of lenses, the second cover plate disposed over the second plurality of optical fibers within the second plurality of v-grooves, wherein the second cover plate is secured to the second base plate.

24. The free-space optical coupling assembly as recited in claim 21, wherein the first optical fiber connector includes a first base plate having a first plurality of through-holes formed through the first base plate, the first plurality of through-holes extending from a back side of the first base plate to a front side of the first base plate, each of the first plurality of through-holes configured to receive and align a corresponding one of the first plurality of optical fibers, the first lens array disposed on the front side of the first base plate, wherein the first plurality of lenses are respectively aligned with the first plurality of through-holes such that optical cores of the first plurality of optical fibers are respectively optically coupled with the first plurality of lenses, and
wherein the second optical fiber connector includes a second base plate having a second plurality of through-holes formed through the second base plate, the second plurality of through-holes extending from a back side of the second base plate to a front side of the second base plate, each of the second plurality of through-holes configured to receive and align a corresponding one of the second plurality of optical fibers, the second lens array disposed on the front side of the second base plate, wherein the second plurality of lenses are respectively aligned with the second plurality of through-holes such that optical cores of the second plurality of optical fibers are respectively optically coupled with second first plurality of lenses.

25. The free-space optical coupling assembly as recited in claim 24, wherein the first optical fiber connector includes a first plug component having a first receiver slot and a second receiver slot, wherein the second optical fiber connector includes a second plug component having a first receiver slot and a second receiver slot, wherein the free-space optical coupling assembly further includes a first alignment pin disposed within both the first receiver slot of the first optical fiber connector and the first receiver slot of the second optical fiber connector, and wherein the free-space optical coupling assembly further includes a second alignment pin disposed within both the second receiver slot of the first optical fiber connector and the second receiver slot of the second optical fiber connector.

26. The free-space optical coupling assembly as recited in claim 25, wherein the first and second receiver slots of the first optical fiber connector and the first and second receiver slots of the second optical fiber connector are collectively configured to provide for optical alignment of the first lens array of the first optical fiber connector with the second lens array of the second optical fiber connector when the first alignment pin is inserted into the first receiver slots of the first and second optical fiber connectors and the second alignment pin is inserted into the second receiver slots of the first and second optical fiber connectors.

27. The free-space optical coupling assembly as recited in claim 26, wherein each of the first and second receiver slots of the first optical fiber connector has a first controlled depth, wherein each of the first and second receiver slots of the second optical fiber connector has a second controlled depth, wherein the first controlled depth and the second controlled depth in combination with a length of the first alignment pin and a length of the second alignment pin provide for control of a spacing between the first optical fiber connector and the second optical fiber connector.

28. The free-space optical coupling assembly as recited in claim 26, further comprising:
a spreader component disposed between the first optical fiber connector and the second optical fiber connector, the spreader component including a first through-hole through which the first alignment pin is disposed, the spreader component including a second through-hole through which the second alignment pin is disposed, wherein a length of the spreader component provides for control of a spacing between the first optical fiber connector and the second optical fiber connector.

29. The free-space optical coupling assembly as recited in claim 26, further comprising:
a locking device disposed within both a first receiver region within the first optical fiber connector and a second receiver region within the second optical fiber connector, wherein the locking device is configured to control a spacing between the first optical fiber connector and the second optical fiber connector.

30. The free-space optical coupling assembly as recited in claim 29, wherein the locking device extends across an entirety of a top of the first optical fiber connector, the spacing between the first optical fiber connector and the second optical fiber connector, and an entirety of a top of the second optical fiber connector.

31. The free-space optical coupling assembly as recited in claim 24, wherein the first optical fiber connector includes an attachment channel, wherein the second optical fiber connector includes an attachment engagement member disposed within the attachment channel of the first optical fiber connector, wherein the attachment channel and the attachment engagement member collectively provide for optical alignment of the first lens array of the first optical fiber connector with the second lens array of the second optical fiber connector, and wherein the attachment channel and the attachment engagement member collectively provide for control of a spacing between the first optical fiber connector and the second optical fiber connector.
